(19) United States
(12) Patent Application Publication
(10) Pub. No.: US 2014/0162641 A1
(43) Pub. Date: Jun. 12, 2014

(54) SYSTEM, A FEMTOCELL HAVING THE SAME, AND METHOD FOR CONTROLLING USER EQUIPMENT TO CONNECT TO WIRELESS LOCAL AREA NETWORK

(71) Applicant: HON HAI PRECISION INDUSTRY CO., LTD., New Taipei (TW)

(72) Inventors: Cho-Han LIN, New Taipei (TW); Che-Ming KUO, New Taipei (TW); Han-Chun CHIANG, New Taipei (TW)

(73) Assignee: HON HAI PRECISION INDUSTRY CO., LTD., New Taipei (TW)

(21) Appl. No.: 13/853,070

(22) Filed: Mar. 29, 2013

(30) Foreign Application Priority Data
Dec. 7, 2012 (TW) 101145921

(51) Int. Cl. H04W 48/20

(52) U.S. Cl. CPC H04W 48/20
USPC 455/435.1

(57) ABSTRACT

A method for allowing and managing user equipment to connect to wireless local network from cellular network via a femtocell is provided. The method includes the steps of: broadcasting an RF signal within a predetermined area to allow the user equipment within the predetermined area to register with the femtocell; broadcasting a paging signal to search for at least one hotspot within a wireless cellular network coverage area when the user equipment has registered with the femtocell; establishing a connection between the femtocell and a found hotspot; sending a request to the found hotspot for obtaining connection information; sending the connection information to the user equipment registered with the femtocell, allowing the user equipment to access the wireless local area network via the found hotspot.

### BACKGROUND

1. Technical Field

The present disclosure relates to femtocells, and particularly to a femtocell and a method for controlling user equipment to connect to wireless local network from wireless cellular network via the femtocell.

2. Description of Related Art

A femtocell is a small, low-power cellular base station, which is used to improve cellular network coverage within a small area, for example in home and small offices, thus allowing service providers to extend service coverage indoors. However, restrictions based upon the selectable location and bandwidth cost of the femtocell may limit the deployment of the femtocell within the area of wireless coverage of the cellular network, thus, the cellular network may not be able to provide a satisfactory data rate to user equipment when more and more user equipment is connected to the cellular network.

Therefore, what is needed is a means to solve the problem described above.

### BRIEF DESCRIPTION OF THE DRAWINGS

Many aspects of the present disclosure should be better understood with reference to the following drawings. The modules in the drawings are not necessarily drawn to scale, the emphasis instead being placed upon clearly illustrating the principles of the present disclosure. Moreover, in the drawings, like reference numerals designate corresponding portions throughout the views.

FIG. 1 is a perspective view of an applied environment of a femtocell, in accordance with an exemplary embodiment.

FIG. 2 is a block diagram of the femtocell of FIG. 1, in accordance with an exemplary embodiment.

FIG. 3 is a flowchart of a method for controlling user equipment to connect to wireless local area network from cellular network via the femtocell of FIG. 1, in accordance with an exemplary embodiment.

### DETAILED DESCRIPTION

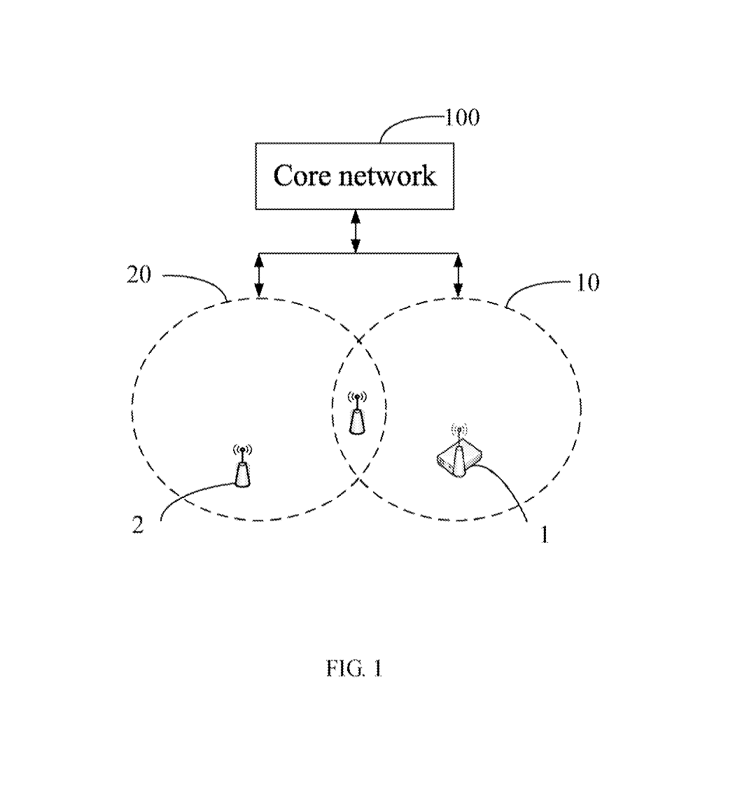

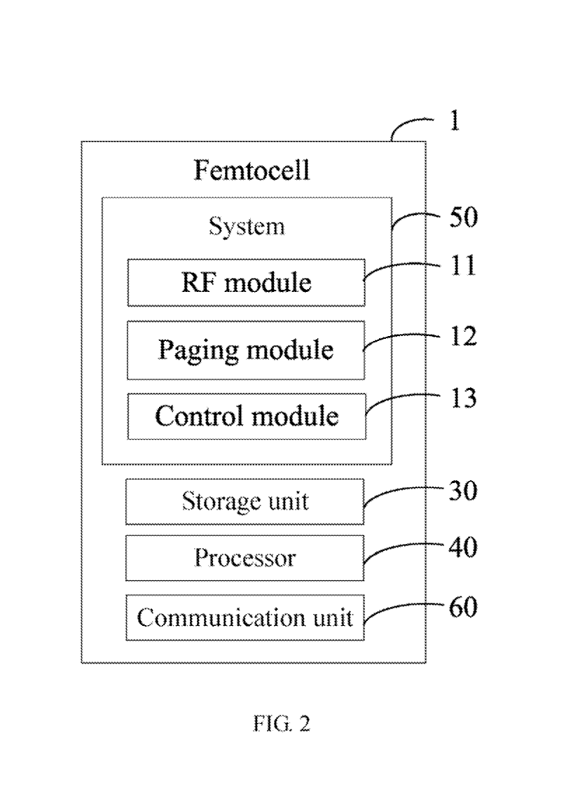

FIG. 1 illustrates an applied environment of a femtocell 1 according to an exemplary embodiment. The femtocell 1 is deployed within a wireless coverage area of a cellular network 10. The cellular network 10 is equipped with a core network 100 and functions as an access network for connecting a user equipment (e.g., a mobile terminal or a tablet computer) to the core network 100. A wireless local area network 20 is connected to the core network 100 and functions as an access network for connecting the user equipment to the core network 100. At least one hotspot 2 which can offer a wireless internet connection to user equipment is deployed within a wireless coverage area of the wireless local area network 20. There is overlap area between the wireless coverage area of the cellular network 10 and the wireless local area network 20, and one or more hotspots 2 may be deployed within the overlap area. The femtocell 1 includes a storage unit 30 and a processor 40 (further shown in FIG. 2). The storage unit 30 stores a system 50. The system 50 includes a variety of modules executed by the processor 40 to provide the functions of the system 50. In the embodiment, the system 50 is executed by the processor 40 to control the user equipment which has registered to access the wireless local area network 20 from the cellular network 10 via the hotspot 2, thereby reducing the communication burden on the femtocell 1 and providing greater data rate to the user equipment. The cellular network 10 can be 3G (3rd-generation) wireless network or LTE (Long Term Evolution) network. The wireless local area network 20 can be 802.11 WiFi network, 802.16 WiMa network or Bluetooth network or similar.

Referring to FIG. 2, the system 50 of the femtocell 1 includes a radio frequency (RF) module 11, a paging module 12, and a control module 13.

The RF module 11 broadcasts an RF signal within a predetermined area. Thus, the user equipment within the predetermined area can communicate with the femtocell 1 and register with the femtocell 1, that is, the femtocell 1 can function as a base station and allow the user equipment to access the core network 100 via the cellular network 10.

The paging module 12 broadcasts a paging signal to search for at least one hotspot 2 which can provide data transmission service to the user equipment within the wireless coverage area of the cellular network 10.

The control module 13 controls a communication unit 60 of the femtocell 1 to establish a connection between the femtocell 1 and a found hotspot 2 when at least one hotspot 2 is found, and controls the communication unit 60 to send a request to the found hotspot 2 for obtaining connection information relating to the found hotspot 2. In the embodiment, the connection information includes a SSID (Service Set Identifier) of the hotspot 2. In an alternative embodiment, the communication in the wireless local area network 20 is encrypted. In this case, the connection information may further include a passkey designated for connecting the user equipment to the wireless local area network 20.

The control module 13 further controls the communication unit 60 of the femtocell 1 to send the connection information of the found hotspot 2 to the user equipment registered with the femtocell 1, thus, the user equipment can access the wireless local area network 20 via the found hotspot 2 according to the connection information.

In another alternative embodiment, the connection information obtained by the control module 13 further includes information as to the maximum bandwidth of the hotspot 2 assignable to the user equipment. Specifically, one hotspot 2 with a greater maximum bandwidth assignable can provide the user equipment with greater data rate. In this case, when at least two hotspots 2 are found, the control module 13 further determines which one of the hotspots 2 has the greatest assignable maximum bandwidth from the found hotspots 2, and then controls the communication unit 60 to send the connection information of the determined hotspot 2 to the user equipment.

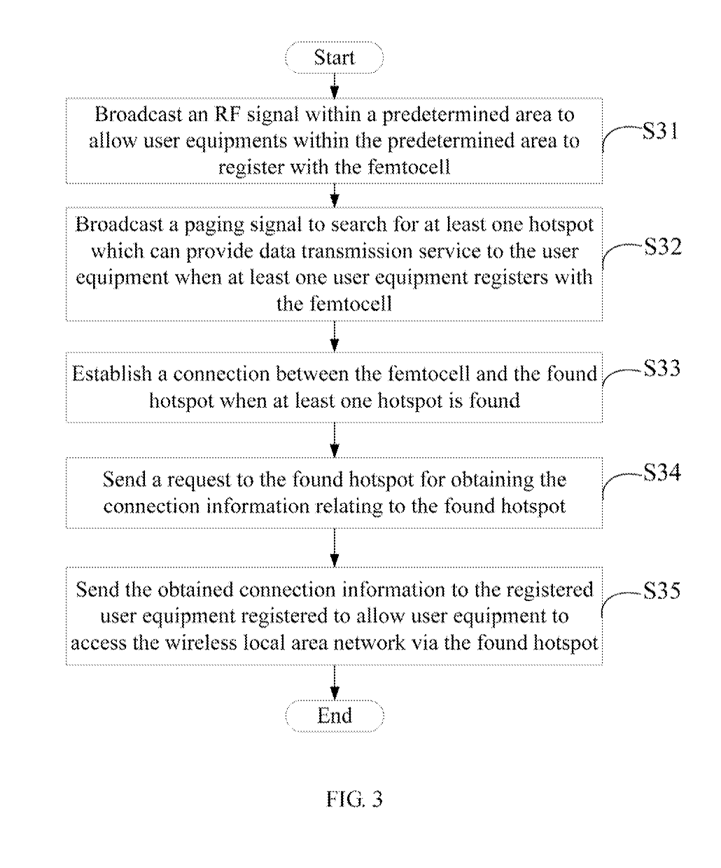

FIG. 3 is a flowchart of a method for controlling a user equipment to connect to wireless local area network 20 from cellular network 10 via the femtocell 1, in accordance with an exemplary embodiment.

In step S31, the RF module 11 broadcasts an RF signal within a predetermined area. Thus, the user equipment within the predetermined area can communicate with the femtocell 1 and register with the femtocell 1.

In step S32, the paging module 12 broadcasts a paging signal to search for at least one hotspot 2 which can provide data transmission service to the user equipment within the wireless coverage area of the cellular network 10 when at least one user equipment has registered with the femtocell 1.

In step S33, the control module 13 controls the communication unit 60 of the femtocell 1 to establish a connection between the femtocell 1 and the found hotspot 2 when at least one hotspot 2 has been found.

In step S34, the control module 13 controls the communication unit 60 to send a request to the found hotspot 2, to obtain the connection information of the found hotspot 2. In the embodiment, the connection information includes a SSID (Service Set Identifier) of the hotspot 2. In an alternative embodiment, the communication in the wireless local area network 20 is encrypted. In this case, the connection information may further include a passkey designated for connecting the user equipment to the wireless local area network 20.

In step S35, the control module 13 controls the communication unit 60 of the femtocell 1 to send the connection information of the found hotspot 2 to the user equipment registered with the femtocell 1, thus the user equipment can access the wireless local area network 20 via the found hotspot 2 according to the connection information.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A femtocell deployed within a wireless coverage area of a cellular network, the cellular network being equipped with a core network, a wireless local area network being connected to the core network, at least one hotspot being deployed within a wireless local area network coverage area, an overlap area being existed between the wireless local area network coverage area and the wireless cellular network coverage area, the femtocell comprising:
a communication unit;
a storage unit storing a plurality of modules; and
a processor configured to execute the plurality of modules, and the plurality of modules comprising:
an RF module configured to broadcast an RF signal within a predetermined area to allow at least one user equipment within the predetermined area to register with the femtocell;
a paging module configured to broadcast a paging signal to search for at least one hotspot within the wireless cellular network coverage area which provides data transmission service to the user equipment when at least one user equipment registers with the femtocell; and
a control module configured to control the communication unit to establish a connection between the femtocell and one of at least one found hotspot, send a request to the one of the at least one found hotspot for obtaining connection information relating to the one of the at least one found hotspot, and send the obtained connection information to the user equipment registered with the femtocell, the obtained connection information being to allow the user equipment to access the wireless local area network via the one of the at least one found hotspot.

2. The femtocell of claim 1, wherein the connection information comprises a Service Set Identifier of the at least one found hotspot.

3. The femtocell of claim 1, wherein communication in the wireless local area network is encrypted; and the connection information comprises a passkey designated for connecting the user equipment to the wireless local area network.

4. The femtocell of claim 1, wherein the connection information relating to the one of the at least one found hotspot comprises a maximum bandwidth of each of the at least one found hotspot assignable to the user equipment; when at least two hotspots are found, the control module is further configured to determine which of the at least one found hotspot has a greatest assignable maximum bandwidth, and control the communication unit to send the connection information of a hotspot with the greatest assignable maximum bandwidth to the user equipment registered with the femtocell.

5. A system applied in a femtocell, the femtocell deployed within a wireless coverage area of a cellular network, the cellular network being equipped with a core network, a wireless local area network being connected to the core network, at least one hotspot being deployed within a wireless local area network coverage area, an overlap area existing between the wireless local area network coverage area and the wireless cellular network coverage area, the system comprising:
an RF module configured to broadcast an RF signal within a predetermined area to allow at least one user equipment within the predetermined area to register with the femtocell;
a paging module configured to broadcast a paging signal to search for at least one hotspot within the wireless cellular network coverage area which provides data transmission service to the user equipment when at least one user equipment registers with the femtocell; and
a control module configured to control a communication unit of the femtocell to establish a connection between the femtocell and one of at least one found hotspot, send a request to the one of the at least one found hotspot for obtaining connection information relating to the one of the at least one found hotspot, and send the obtained connection information to the user equipment registered with the femtocell, the obtained connection information being to allow the user equipment to access the wireless local area network via the one of the at least one found hotspot.

6. The system of claim 5, wherein the connection information comprises a Service Set Identifier of the at least one found hotspot.

7. The system of claim 5, wherein communication in the wireless local area network is encrypted; and the connection information comprises a passkey designated for connecting the user equipment to the wireless local area network.

8. The system of claim 5, wherein the connection information relating to the one of the at least one found hotspot comprises a maximum bandwidth of each of the at least one found hotspot assignable to the user equipment; when at least two hotspots are found, the control module is further configured to determine which of the at least one found hotspot has a greatest assignable maximum bandwidth, and control the communication unit to send the connection information of a hotspot with the greatest assignable maximum bandwidth to the user equipment registered with the femtocell.

9. A method for controlling a user equipment to connect to wireless local network from cellular network via a femtocell, the femtocell deployed within a wireless coverage area of the cellular network, the cellular network being equipped with a core network, a wireless local area network being connected to the core network, at least one hotspot being deployed within a wireless local area network coverage area, an overlap area existing between the wireless local area network coverage area and the wireless cellular network coverage area, the method comprising:
broadcasting an RF signal within a predetermined area to allow the user equipment within the predetermined area to register with the femtocell;
broadcasting a paging signal to search for at least one hotspot within the wireless coverage area of the cellular network which provides data transmission service to the user equipment when the user equipment registers with the femtocell;
establishing up a connection between the femtocell and one of at least one found hotspot;
sending a request to the one of the at least one found hotspot for obtaining connection information relating to the one of the at least one found hotspot; and
sending the obtained connection information to the user equipment registered with the femtocell, the obtained connection information being to allow the user equipment to access the wireless local area network via the one of the at least one found hotspot.

10. The method of claim 9, wherein the connection information comprises a Service Set Identifier of the at least one found hotspot.

11. The method of claim 9, wherein communication in the wireless local area network is encrypted; and the connection information comprises a passkey designated for connecting the user equipment to the wireless local area network.
